(19) United States
(12) Patent Application Publication
(10) Pub. No.: US 2013/0128019 A1
(43) Pub. Date: May 23, 2013

(54) DISPLAY DEVICE, DISPLAY CONTROL METHOD, DISPLAY CONTROL PROGRAM, AND COMPUTER READABLE RECORDING MEDIUM

(71) Applicants: Hideharu Tajima, Osaka-shi (JP); Go Mori, Osaka-shi (JP)

(72) Inventors: Hideharu Tajima, Osaka-shi (JP); Go Mori, Osaka-shi (JP)

(73) Assignee: Sharp Kabushiki Kaisha, Osaka-shi, Osaka (JP)

(21) Appl. No.: 13/814,267

(22) PCT Filed: Aug. 4, 2011
(86) PCT No.: PCT/JP2011/067890

§ 371 Date: Feb. 5, 2013

(30) Foreign Application Priority Data
Aug. 9, 2010 (JP) 2010-178544

(51) Int. Cl. H04N 13/04

(52) U.S. Cl. CPC H04N 13/0402
USPC 348/59

(57) ABSTRACT

A display device (1) includes: a parallax barrier producing a plurality of sight line directions of the parallax video images displayed in a display section (60) so that the parallax video images are displayed separately in the plurality of sight line directions; and a display controlling section (10) controlling, for each of the plurality of sight line directions, display of the parallax video images and allowing a stereoscopic video image to be viewed via liquid crystal shutter glasses (70), the parallax video images being displayed separately in the plurality of sight line directions produced by the parallax barrier. Thereby, the display device (1) can allow a plurality of viewers to respectively view video images of different display modes by using a parallax barrier, when the display device (1) allows a viewer to view the stereoscopic video image via the liquid-crystal shutter glasses (70) for switching whether or not to allow each of right and left eyes to view the stereoscopic video image.

### TECHNICAL FIELD

The present invention relates to a display device, a display control method, a display control program, and a computer-readable storage medium in a display device that allows a viewer to view a stereoscopic video image via a visual-recognition switching mechanism for switching whether or not to allow each of right and left eyes to view the stereoscopic video image, each of which display device, display control method, display control program, and computer-readable storage medium allows a plurality of viewers to view images of different display modes by use of video image dividing means such as a parallax barrier.

### BACKGROUND ART

In recent years, a method for viewing a 3D video image has been diligently studied. Generally, in a case where a viewer views a 3D video image, the viewer wears liquid-crystal shutter glasses, and a right-eye image and a left-eye image only for use in 3D video images are viewed by a right eye and a left eye. This method uses a principle in which an image can be seen stereoscopically by using parallax of right and left eyes. As one example of conventional techniques for displaying 3D video images, Cited Document 1 discloses a stereoscopic video image display device that allows an image to be stereoscopically viewed via liquid-crystal shutter glasses.

Such a technique of displaying a 3D video image can be applied, for example, to 3D mobile handsets, 3D games, 3D computer monitors, 3D laptop displays, 3D workstations, and 3D professional image processing (for example, medicine, design, or construction).

Further, as another technique, there has been developed such a display device that allows a plurality of viewers to view different moving images, respectively, from a single display via a parallax barrier. For example, Cited Document 2 discloses a multi-view display device that can display separate video images toward different sight line directions, respectively, by use of a parallax barrier.

Such multi-view display devices can be applied not only to familiar devices such as car navigation systems in which an image is displayed toward a driver's seat and a different image is displayed toward a passenger seat, mobile phones, PDAs (personal digital assistants), PCs, and TV receivers, but also to measurement devices, medical devices, and industrial equipment.

As described above, various video image viewing modes are provided to viewers as a result of recent development of video display techniques.

### CITATION LIST

### Cited Document

[Cited Document 1] Japanese Patent Application Publication, Tokukaisho, No. 62-61493 A (Publication date: Mar. 18, 1987)
[Cited Document 2] Japanese Patent Application Publication, Tokukai, No. 2007-41490 A (Publication date: Feb. 15, 2007)

### SUMMARY OF INVENTION

### Technical Problem

However, Cited Documents 1 and 2 have the following problem.

That is, only one of a 2D video image and a 3D video image could be displayed on a display device conventionally even by use of the techniques of Cited Documents 1 and 2. Therefore, a conventional display device could not allow viewers to view both a 2D video image and a 3D video image at the same time via a parallax barrier.

The present invention is attained in view of the above problem, and an object of the present invention is to achieve a display device, a display control method, a display control program, and a computer-readable storage medium, each of which makes it possible to display a 2D video image and a 3D video image at the same time.

### Solution to Problem

In order to solve the above problem, a display device of the present invention capable of displaying a two-dimensional video image and a three-dimensional video image that is viewed by using parallax of left and right eyes of a viewer, the display device includes: pixel determination means determining, automatically or in response to an input operation of a viewer, a three-dimensional pixel group for a three-dimensional video image and a two-dimensional pixel group for a two-dimensional video image from among pixels in a display section of the display device; pixel-group display control means individually controlling display of each of the three-dimensional pixel group and the two-dimensional pixel group; and a parallax barrier of a parallax type or lenticular type.

In the above configuration, the pixel-group display control means individually controls display of each of the three-dimensional pixel group and the two-dimensional pixel group. Accordingly, the display device of the present invention is capable of simultaneously displaying the three-dimensional video image and the two-dimensional video image.

In order to solve the above problem, a display device of the present invention displaying parallax video images viewed by using parallax of left and right eyes of a viewer and allowing the viewer to view a stereoscopic video image via a visual-recognition switching mechanism for switching whether or not to allow each of the right and left eyes to view the stereoscopic video image, the display device includes: a sight-line-direction dividing section producing a plurality of sight line directions of the parallax video images displayed in a display section so that the parallax video images are displayed separately in the plurality of sight line directions; and display control means controlling, for each of the plurality of sight line directions, display of the parallax video images and allowing the stereoscopic video image to be viewed via the visual-recognition switching mechanism, the parallax video images being displayed separately in the plurality of sight line directions produced by the sight-line-direction dividing section.

Further, in order to solve the above problem, a display control method of the present invention for displaying parallax video images viewed by using parallax of left and right eyes of a viewer and allowing the viewer to view a stereoscopic video image via a visual-recognition switching mechanism for switching whether or not to allow each of the right and left eyes to view the stereoscopic video image, the display control method includes the steps of: displaying the parallax video images in a display section provided in a display device so that the parallax video images are displayed separately in a plurality of sight line directions produced by a sight-line-direction dividing section provided in the display device; and controlling, for each of the plurality of sight line directions, display of the parallax video images and allowing the stereoscopic video image to be viewed via the visual-recognition switching mechanism, the parallax video images being displayed separately in the plurality of sight line directions produced by the sight-line-direction dividing section.

In the above configuration, the sight-line-direction dividing section produces a plurality of sight line directions of parallax video images displayed in the display section so that the parallax video images are displayed separately in the plurality of sight line directions. At this time, the display control means controls, for each of the plurality of sight line directions, display of the parallax video images displayed separately in the plurality of sight line directions produced by the sight-line-direction dividing section. Therefore, the display control means makes it possible to realize a viewing mode in which a viewer can view a stereoscopic video image via the visual-recognition switching mechanism in addition to a viewing mode in which a viewer can view parallax video images directly without the visual-recognition switching mechanism.

As described above, the display device (display control method) of the present invention solves a conventional problem, that is, a problem that there has been no display device that is capable of displaying a stereoscopic video image viewed by using parallax of right and left eyes and that also includes a sight-line-direction dividing section such as a parallax barrier. In addition, in a case where a plurality of viewers are present and, among the plurality of viewers, at least one viewer desires to view a parallax video image (2D video image) and other viewer(s) desires to view a stereoscopic video image (3D video image), the display device can allow each of the plurality of viewers to respectively view video images of different display modes. Therefore, the display device also can simultaneously satisfy requests of the plurality of viewers.

Note that in the display device (display control method) of the present invention, the sight-line-direction dividing section produces a plurality of sight line directions so that parallax video images displayed in the display section are displayed separately in the plurality of sight line directions. Therefore, even when three or more viewers are present, the display device of the present invention is capable of simultaneously realizing viewing modes that the three or more viewers respectively desire. In this point, the present invention also provides a display device that is more convenient.

### Advantageous Effects of Invention

As described above, a display device of the present invention is configured to include: pixel determination means determining, automatically or in response to an input operation of a viewer, a three-dimensional pixel group for a three-dimensional video image and a two-dimensional pixel group for a two-dimensional video image from among pixels in a display section of the display device; pixel-group display control means individually controlling display of each of the three-dimensional pixel group and the two-dimensional pixel group; and a parallax barrier of a parallax type or lenticular type.

Therefore, the present invention can provide a display device capable of simultaneously displaying a two-dimensional video image and a three-dimensional video image.

### BRIEF DESCRIPTION OF DRAWINGS

FIG. 1 is a block diagram illustrating an internal configuration of a display device in accordance with the present embodiment.

FIG. 2 is a block diagram illustrating an internal configuration of another display device in accordance with the present embodiment.

FIG. 3 is a schematic view of an arrangement of a 2D/3D video image viewing system including the display device in accordance with the present embodiment.

FIG. 4 is a cross-sectional view illustrating a display section of the display device in accordance with the present embodiment.

FIG. 5 is a diagram illustrating an operation in which a 3D video image viewer wearing liquid crystal shutter glasses views a 3D video image and a 2D video image viewer views a 2D video image, i.e., an operation in which no special process is performed on a 2D video image.

FIG. 6 is a diagram illustrating an operation in which a 3D video image viewer wearing liquid crystal shutter glasses views a 3D video image and a 2D video image viewer views a 2D video image, i.e., an operation in which a scene (video image) where a color of pixels is black is inserted in the 2D video image.

### DESCRIPTION OF EMBODIMENTS

The following describes a display device 1 in accordance with the present invention with reference to drawings. In the following description, identical members and components are given identical reference signs. These members and components given the identical reference signs are respectively given the same names and have the same functions. Accordingly, the detailed description thereof is not repeatedly provided.

[Schematic Configuration of 2D/3D Video Image Viewing System]

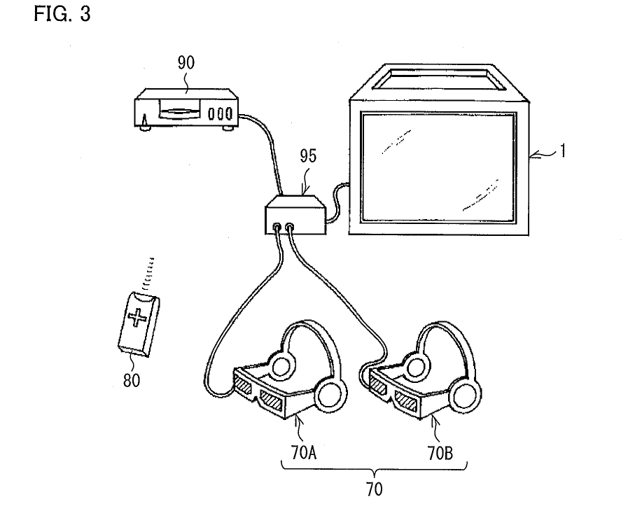

Prior to description of the display device 1, the following describes a 2D/3D video image viewing system including the display device 1, with reference to FIG. 3. FIG. 3 is a schematic view of an arrangement of the 2D/3D video image viewing system including the display device 1.

The 2D/3D video image viewing system in accordance with the present embodiment is such that: parallax images that are reproduced by a recording/reproducing device 90 and that are displayed on the display device 1 are viewed as a three-dimensional video image (hereinafter, referred to also as “3D video image” or “stereoscopic video image”) by a viewer wearing liquid-crystal shutter glasses (visual-recognition switching mechanism) 70 whereas the same parallax images are viewed as a two-dimensional video image (hereinafter, referred to as “2D video image”) by a viewer with naked eyes. The term “parallax images” means images that are viewed by using parallax of right and left eyes of a viewer. The “parallax images” indicate a right-eye image and a left-eye image for exclusive use in 3D video image.

As illustrated in FIG. 3, the 2D/3D video image viewing system of the present embodiment mainly includes: the display device 1; liquid-crystal shutter glasses (visual-recognition switching mechanism) 70; an operation section 80; a recording/reproducing device 90; and a relay 95.

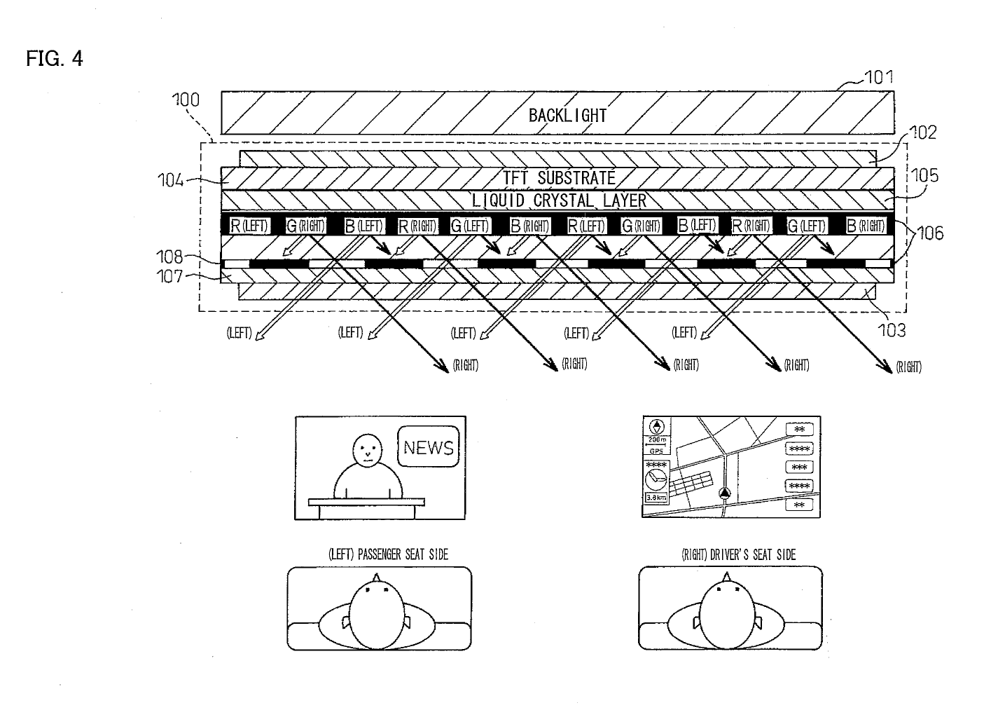

The display device 1 displays a video image that is reproduced by the recording/reproducing device 90, and examples of the display device 1 encompass LCDs (liquid crystal displays), PDPs (plasma display panels), and CRT (cathode-ray tube) displays. In the display device 1, a parallax barrier (sight-line-direction dividing section) 108 (not shown) is included in a display section, and detailed description thereof will be provided below with reference to FIG. 4.

The liquid-crystal shutter glasses 70 include a three-layer structure formed by a polarizing plate, a liquid crystal filter, and a polarizing plate. The liquid-crystal shutter glasses 70 are configured to be capable of switching between two types of polarized transmitted light by use of the liquid crystal filter. More specifically, the liquid-crystal shutter glasses 70 open and close respective shutters for right and left eyes by use of a shutter driving signal for controlling passage and blocking of light. The shutter driving signal is synchronized with a desired video-image signal that is supplied from the display device 1 and that has a field frequency, and a signal width of this shutter driving signal corresponds to that of the video-image signal. Therefore, by opening and closing the shutters by use of the shutter driving signal, a viewer can view, with a shutter open, only “a video image corresponding to one video-image signal” selected from a plurality of video-image signals, and cannot view other video images with the shutter closed. This allows the viewer to view only a desired video images.

Note that, in FIG. 3, the liquid-crystal shutter glasses 70 have a wired connection, by use of a cable, to the display device 1 via the relay 95. However, the liquid-crystal shutter glasses 70 may have a wireless connection to the relay 95 and/or the display device 1.

Further, in FIG. 3, the relay 95 is connected to two pairs of liquid-crystal shutter glasses 70A and 70B. The number of pairs of liquid-crystal shutter glasses 70, however, is not limited to two, and a pair or three or more pairs of liquid-crystal shutter glasses 70 may be used.

The operation section 80 is a section into which a viewer inputs an instruction signal for causing the display device 1 and the recording/reproducing device 90 to operate. This operation section 80 may be constituted by, for example, a remote controller for use in a remote control operation of the display device 1, an operation button that is provided in the display device 1 itself, or a mouse or keyboard that is connected to the display device 1. The instruction signal inputted by the viewer by use of the operation section 80 is sent, via an input/output control section (not illustrated), into sections of the display device 1 and/or sections of the recording/reproducing device 90. The viewer can thereby operate the display device 1 and/or the recording/reproducing device 90.

In the present embodiment, the operation section 80 is also used to, for example, determine, change, or confirm a sight line direction in which a 3D video image and/or a 2D video image are/is displayed by the parallax barrier 108 (described below). That is, a viewer can input, into the display device 1 by an input operation via the operation section 80, a display mode (2D/3D) of a video image that the viewer wants to view and a sight line direction in which the video image is to be displayed.

Note that FIG. 3 illustrates only one operation section 80. However, two operation sections 80 may be provided for the display device 1 and the recording/reproducing device 90, respectively.

The recording/reproducing device 90 is for reproducing video image information that is recorded in an information recording medium such as a BD (Blu-Ray (registered trademark) Disc), a DVD (digital versatile disc), or an HDD (hard disc drive), and may be a publicly-known recording/reproducing device.

Note that FIG. 3 illustrates a case where a video-image signal reproduced by the recording/reproducing device 90 is inputted into the display device 1. However, the present embodiment may be arranged such that the display device 1 displays a video image corresponding to video image data or the like received by use of a service that distributes, with use of not the recording/reproducing device 90 but an IP (Internet Protocol) network, content such as a real-time broadcast or a movie. For example, it is possible to display, on the display device 1, a video image corresponding to video image data obtained by use of (A) a linear TV, which is a broadcast service that distributes a program in real time in accordance with a predetermined broadcast schedule, or (B) VoD (video on demand), which is a unicast service that distributes content to a content processing device in response to a request for distribution from a receiver.

Note that the present embodiment is described on the assumption that video images to be displayed on the display device 1 are (A) a 3D video image constituted by a right-eye image and a left-eye image, which 3D video image is viewed by using parallax of right and left eyes of a viewer, and (B) a 2D video image (the right-eye image or the left-eye image). However, the video images are not limited thereto.

The relay 95 connects the display device 1, the liquid-crystal shutter glasses 70, and the recording/reproducing device 90 with one another. Note, however, that the relay 95 is not necessarily required in a case where, for example, the liquid-crystal shutter glasses 70 and the recording/reproducing device 90 are directly connected to the display device 1 or the display device 1 and the liquid-crystal shutter glasses 70 have a wireless connection.

[Regarding Parallax Barrier]

The following description will discuss, with reference to FIG. 4, the parallax barrier provided in the display section of the display device 1. FIG. 4 is a cross-sectional view of the display device 1.

As illustrated in FIG. 4, the display section of the display device 1 includes: a liquid crystal panel 100; a backlight 101; a polarizing plate 102 provided on a backlight side of a liquid crystal panel; a polarizing plate 103 provided on a front surface of the liquid crystal panel which front surface is a surface provided in a light-outgoing direction (on a light-outgoing side); a TFT (thin film transistor) substrate 104; a liquid crystal layer 105; a color filter substrate 106; a glass substrate 107; and the parallax barrier 108. The liquid crystal panel 100 is configured, by sandwiching between two polarizing plates 102 and 103, (A) a pair of substrates constituted by the TFT substrate 104 and the color filter substrate 106 that faces the TFT substrate 104, between which pair of substrates the liquid crystal layer 105 is sandwiched and (B) the parallax barrier 108 and the glass substrate 107 that are provided on a front surface of the pair of substrates which front surface is provided in the light-outgoing direction (on the light-outgoing side). The liquid crystal panel 100 is provided so as to be slightly apart from the backlight 101. Further, the liquid crystal panel 100 has pixels each of which has a color of RGB (three primary colors).

Video images to be displayed by use of the pixels of the liquid crystal panel 100 are displayed separately in a plurality of sight line directions by use of the parallax barrier 108. FIG. 4 illustrates an example where the display device 1 is used for a car navigation system which displays a video image toward a driver's seat and a different image toward a passenger seat in a vehicle. The pixels of the liquid crystal panel 100 are subjected to display control while being divided into pixels for displaying an image for a left side (passenger seat side) of FIG. 4 and pixels for displaying an image for a right side (driver's seat side) of FIG. 4.

As illustrated in FIG. 4, the parallax barrier 108 allows an image displayed by use of the pixels for left-side display (display for passenger seat side) to be viewed from the left side (passenger seat side) but not to be viewed from the right side (driver's seat side). Meanwhile, the parallax barrier 108 allows an image displayed by use of the pixels for right-side display (display for driver's seat side) to be viewed from the right side (driver's seat side) but not to be viewed from the left side (passenger seat side). Therefore, different displays are provided to a driver and a passenger, respectively. That is, in the example of FIG. 4, a driver can receive map information for car navigation while a passenger can watch a DVD movie or the like.

Note that the parallax barrier 108 can be configured to display different images respectively in a plurality of directions (for example, three directions), by changing a configuration of pixels of the liquid crystal panel. Further, the parallax barrier 108 can be various types of barriers such as a parallax type and a lenticular type. Furthermore, the parallax barrier 108 can be configured to be detachable with respect to the display section of the display device 1 if the parallax barrier 108 and the pixels of the liquid crystal panel 100 can be aligned with each other.

### [Internal Configuration of Display Device 1]

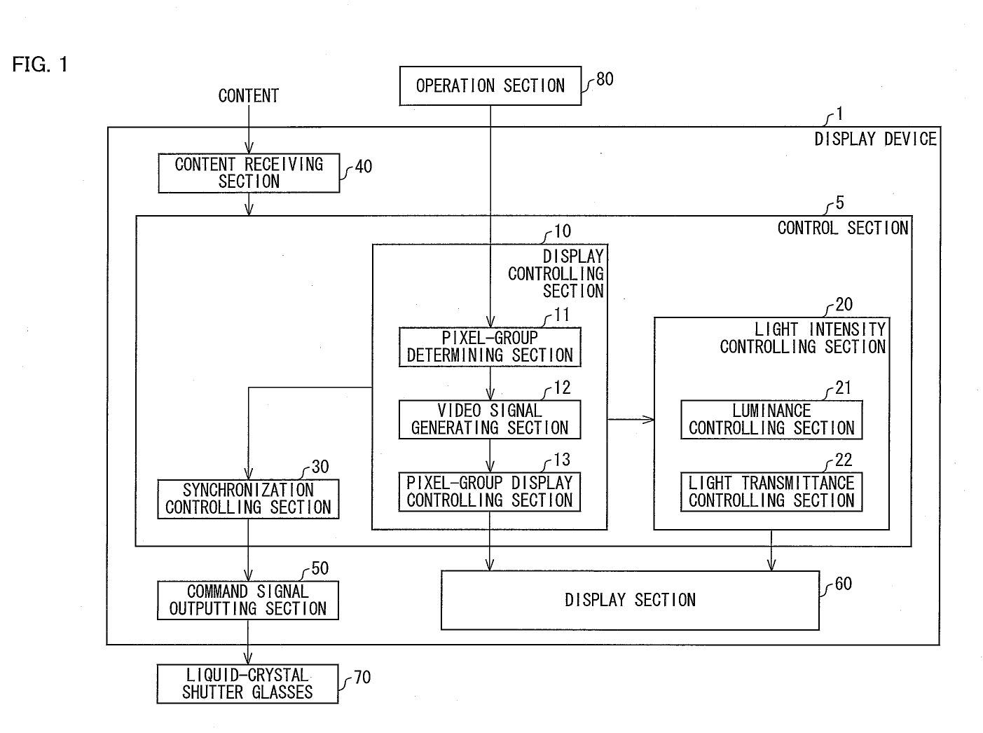

Next, the following description deals with an internal configuration of the liquid crystal display device 1 with reference to FIG. 1. FIG. 1 is a block diagram illustrating an internal configuration of the display device 1.

The display device 1 displays video images so that (i) a 3D video image is displayed with respect to a viewer who wears the liquid-crystal shutter glasses 70 and (ii) a 2D video image is displayed with respect to a viewer with naked eyes. The display device 1 includes at least (i) a control section 5 for controlling each section of the display device 1, (ii) a content receiving section 40 for obtaining, from an external recording/reproducing device 90, an IP network, a radio wave for TV broadcasting, or the like, a signal (a parallax video-image signal) for displaying parallax video images on the display device 1, (iii) a command signal outputting section 50 for outputting, in accordance with a display timing signal received from a synchronization controlling section 30 (described later), a shutter driving signal which instructs the liquid crystal shutter glasses 70 to open/close glasses of the liquid crystal shutter glasses 70, and (iv) a display section 60 including the parallax barrier 108, and the like.

Note that the display device 1 is connected to the liquid-crystal shutter glasses 70 and the operation section 80 via cables or wirelessly so that the display device 1 can communicate with the liquid-crystal shutter glasses 70 and the operation section 80.

The content receiving section 40 obtains (i) a video-image signal reproduced by the recording/reproducing device 90 or (ii) a video-image signal corresponding to video image data or the like received by use of a service that distributes content such as a real-time broadcast or a movie with use of an IP network. Then, the content receiving section 40 outputs the video-image signal thus obtained to the control section 5. In the present embodiment, the content receiving section 40 obtains a parallax video-image signal for displaying, on the display device 1, parallax video images (a right-eye video image and a left-eye video image) that are viewed by using parallax of left and right eyes of a viewer.

The control section 5 carries out overall control of sections of the display device 1. The control section 5 includes a display controlling section (display control means) 10, a light intensity controlling section 20, and a synchronization controlling section (synchronization control means) 30.

The display controlling section 10 obtains a parallax video-image signal from the content receiving section 40. Then, the display controlling section 10 controls, for each of sight line directions produced by the liquid crystal shutter glasses 70, display of parallax video images that are displayed in the sight line directions and in accordance with the parallax video-image signal. This makes it possible to view a 3D video image (a stereoscopic video image) via the liquid-crystal shutter glasses 70. Here, the display controlling section 10 controls display of parallax video images each of which is displayed in a pixel group that is associated with a single sight line direction from among such a plurality of sight line directions. In this control of display, the display controlling section 10 causes a pixel group associated with a first sight line direction to alternately display a right-eye video image and a left-eye video image (which are parallax video images) and also causes a pixel group associated with a second sight line direction to display the right-eye video image or the left-eye video image, which second sight line direction is different from the first sight line direction. Each of the pixel groups contains pixels from among a plurality of pixels in the display section 60.

The following description explains the above display control more specifically. The display controlling section 10 includes a pixel-group determining section (pixel-group determination means) 11, a video-image signal generating section (video-image signal generation means) 12, and a pixel-group display controlling section (pixel-group display control means) 13.

The pixel-group determining section 11 determines (i) a three-dimensional pixel group which is, among the pixel groups described above, the pixel group that is caused to alternately display the right-eye video image and the left-eye video image, and (ii) a two-dimensional pixel group which is, among the pixel groups described above, the pixel group that is caused to display the right-eye video image or the left-eye video image.

Specifically, in accordance with such a setting for displaying (i) a 3D video image in the first sight line direction and (ii) a 2D video image in the second sight line direction which is different from the first sight line direction, the pixel-group determining section 11 determines the three-dimensional pixel group and the two-dimensional pixel group.

Note that the pixel-group determining section 11 can be configured to accept an input operation inputted by a viewer via the operation section 80 (described later), and determine the three-dimensional pixel group and the two-dimensional pixel group in response to the input operation. For example, in response to an input operation for changing (i) a sight line direction to a right side of the display device, for a viewer who would like to view a 3D video image, and (ii) a sight line direction to a left side of the display device, for a viewer who would like to view a parallax video image (a 2D video image), the pixel-group determining section 11 can determine the three-dimensional pixel group and the two-dimensional pixel group. A method by which a viewer makes an input operation, an operation screen, and the like can be decided by publicly-known techniques, and therefore detailed explanations thereof are omitted here.

Further, for a case where no input operation is made by a viewer via the operation section 80, pixels corresponding to the three-dimensional pixel group and pixels corresponding to the two-dimensional pixel group may be specified in advance from among the pixels in the display section 60.

In accordance with a parallax video-image signal obtained from the content receiving section 40 directly or via the pixel-group determining section 11, the video-image signal generating section 12 generates (i) a three-dimensional video-image signal for displaying parallax video images in the three-dimensional pixel group determined by the pixel-group determining section 11 and (ii) a two-dimensional video-image signal for displaying a parallax video image in the two-dimensional pixel group determined by the pixel-group determining section 11.

Specifically, in view of a proportion of the number of pixels in the three-dimensional pixel group to the number of pixels in the display section 60, a proportion of the number of pixels in the two-dimensional pixel group to the number of pixels in the display section 60, positions of the three-dimensional pixel group and the two-dimensional pixel group, and the like, the video-image signal generating section 12 generates, from the parallax video-image signal for displaying parallax video images on the display device 1, (i) the three-dimensional video-image signal for displaying parallax video images in the three-dimensional pixel group and (ii) the two-dimensional video-image signal for displaying a parallax video image on the two-dimensional pixel group.

For example, in a case where video images are displayed separately in two sight line directions that are equally produced by use of the parallax barrier 108, the number of pixels required for displaying each of the respective video images in the three-dimensional pixel group and the two-dimensional pixel group is half the number of pixels required for displaying, without using the parallax barrier 108, a regular video image. Accordingly, in this case, the video-image signal generating section 12 generates the three-dimensional video-image signal for displaying parallax video images in the three-dimensional pixel group and the two-dimensional pixel video-image signal for displaying a parallax video image in the two-dimensional pixel group so that in a horizontal direction (a left-to-right direction, a direction perpendicular to a gravitational direction) of the display section 60, (i) a number of pixels in the three-dimensional pixel group is half the total number of pixels in the horizontal direction in the display section 60 and (ii) a number of pixels in the two-dimensional pixel group is half the total number of pixels in the horizontal direction in the display section 60. Then, the video-image signal generating section 12 outputs, to the pixel-group display controlling section 13, the three-dimensional video-image signal and the two-dimensional video-image signal thus generated.

The pixel-group display controlling section 13 (i) causes, in accordance with the three-dimensional video-image signal generated by the video-image signal generating section 12, the three-dimensional pixel group to display a right-eye video image and a left-eye video image, and (ii) causes, in accordance with the two-dimensional video-image signal generated by the video-image signal generating section 12, the two-dimensional pixel group to display the right-eye video image or the left-eye video image.

The light intensity controlling section 20 includes a luminance controlling section (first luminance control means) 21 and a light transmittance controlling section (light transmittance control means) 22.

The luminance controlling section 21 controls a luminance of a backlight included in the display device 1. The display device 1 has an configuration in which (i) a plurality of pixels in the display section 60 are divided into the three-dimensional pixel group and the two-dimensional pixel group, and (ii) these pixel groups are caused to respectively display separate video images which are subjected to display control individually. On this account, a light intensity of each of the pixel groups is lower than a light intensity of the display section 60 in a regular display state (a display state in which the parallax barrier 108 is not used). Further, the viewer of a 3D video image views the 3D video image via the liquid-crystal shutter glasses 70. Accordingly, a light transmittance may be decreased depending on the liquid-crystal shutter glasses 70. This further lowers an intensity of light perceived by the viewer of the 3D video image. This decrease in light intensity becomes more significant as the number of visual line directions produced by the parallax barrier 108 increases.

In view of this, the luminance controlling section 21 controls a luminance of the backlight included in the display device 1 so that the luminance becomes higher, and thereby increases an intensity of light perceived by the viewer of the 3D video image.

Note that the luminance controlling section 21 can receive, from the display controlling section 10, an instruction to increase a luminance of the backlight and then increase a luminance of the backlight according to the instruction. Alternatively, the luminance controlling section 21 can increase a luminance of the backlight in accordance with the number of sight line directions which are produced by the parallax barrier 108.

The light transmittance controlling section 22 controls a light transmittance of the two-dimensional pixel group. The following description deals with such control more specifically. In a case where the luminance controlling section 21 controls a luminance of the three-dimensional pixel group, a light intensity of the two-dimensional pixel group may increase. For example, in a case where the luminance controlling section 21 increases the luminance of the backlight, a light intensity may increase excessively for the viewer of the 2D video image. This is because the three-dimensional pixel group and the two-dimensional pixel group share a single backlight.

In view of this, the light transmittance controlling section 22 decreases a light transmittance of the two-dimensional pixel group so that a light intensity becomes substantially equal to a light intensity obtained under a condition where the right-eye video image or the left-eye video image is displayed in the two-dimensional pixel group without using the parallax barrier 108. This makes it possible to decrease a light intensity perceived by the viewer of the 2D video image.

Note that the light transmittance controlling section 22 can decrease a light transmittance of the two-dimensional pixel group in a case where the luminance controlling section 21 increases a luminance of the backlight. Alternatively, the light transmittance controlling section 22 can perform control in which a light transmittance in the two-dimensional pixel group is decreased the light transmittance, in accordance with a fluctuation in a luminance level of the backlight which luminance level is controlled by the luminance controlling section 21.

The synchronization controlling section 30 synchronizes (i) a display timing at which the pixel-group display controlling section 13 causes the three-dimensional pixel group to display the right-eye video image with (ii) a shutter open/close timing at which a right-eye liquid crystal shutter of the liquid-crystal shutter glasses 70 is opened and a left-eye liquid crystal shutter of the liquid-crystal shutter glasses 70 is closed. Further, the synchronization controlling section 30 synchronizes (i) a display timing at which the pixel-group display controlling section 13 causes the three-dimensional pixel group to display the left-eye video image with (ii) a shutter open/close timing at which the right-eye liquid crystal shutter of the liquid-crystal shutter glasses 70 is closed and the left-eye liquid crystal shutter of the liquid-crystal shutter glasses 70 is opened. These operations can be carried out in such a manner that the synchronization controlling section 30 (i) first receives, from the display controlling section 10, a display timing signal indicating a timing at which each of the right-eye video image and the left-eye video image are displayed in the three-dimensional pixel group, and (ii) then outputs, to the command signal outputting section 50, an instruction to open/close each of the right-eye liquid crystal shutter and the left-eye liquid crystal shutter of the liquid-crystal shutter glasses 70 in synchronization with the display timing signal.

The command signal outputting section 50 outputs, to the liquid-crystal shutter glasses 70, a shutter driving signal which instructs the liquid-crystal shutter glasses 70 to open/close each of the right-eye liquid crystal shutter and the left-eye liquid crystal shutter in accordance with the display timing signal obtained from the synchronization controlling section 30. Then, by using the shutter driving signal and in synchronization with the display timing at which the pixel-group display controlling section 13 causes the three-dimensional pixel group to display the right-eye video image, the liquid-crystal shutter glasses 70 (i) opens the right-eye liquid crystal shutter of the liquid-crystal shutter glasses 70 and (ii) closes the left-eye liquid crystal shutter of the liquid-crystal shutter glasses 70. Further, in accordance with the shutter driving signal and in synchronization with the display timing at which the pixel-group display controlling section 13 causes the three-dimensional pixel group to display the left-eye video image, the liquid-crystal shutter glasses 70 (i) closes the right-eye liquid crystal shutter of the liquid-crystal shutter glasses 70 and (ii) opens the left-eye liquid crystal shutter of the liquid-crystal shutter glasses 70.

[Internal Configuration of Display Device 2]

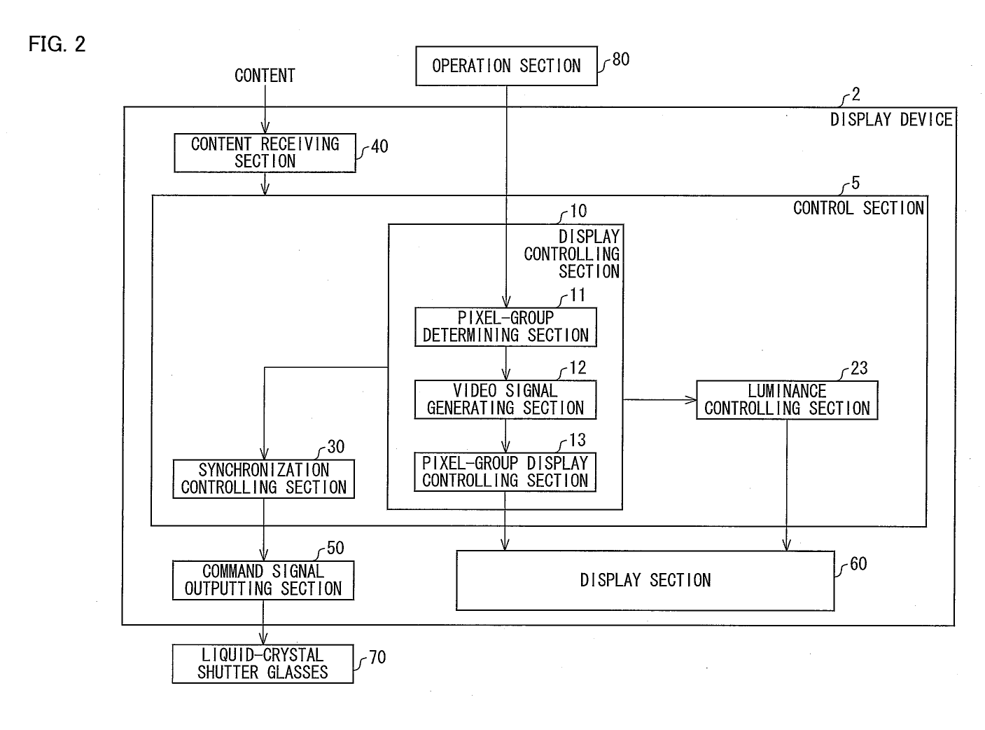

Next, the following description deals with, with reference to FIG. 2, an internal configuration of a display device 2 of a self-luminous type, such as a plasma display device in which pixels themselves emit light. FIG. 2 is a block diagram illustrating the internal configuration of the display device 2. Note that explanation of contents concerning an internal configuration identical to the internal configuration explained above with reference to FIG. 1 is omitted here.

The display device 1 and the display device 2 are different from each other in that the light intensity controlling section 20 of the display device 1 includes the luminance controlling section 21 and the light transmittance controlling section 22, whereas the display device 2 does not include the light transmittance controlling section 22.

The display device 2 is configured such that (i) a plurality of pixels in a display section 60 are divided into a three-dimensional pixel group and a two-dimensional pixel group, and (ii) each of these pixel groups is caused to display a different video image which is subjected to display control individually. Accordingly, a light intensity of each of the pixel groups is lower than a light intensity of the display section 60 in a regular display state (a display state in which the parallax barrier 108 is not used). Further, a viewer of a 3D video image views a 3D video image via liquid-crystal shutter glasses 70. For this reason, a light transmittance decreases depending on the liquid-crystal shutter glasses 70. This further decreases an intensity of light perceived by the viewer of the 3D video image. Such a decrease in an intensity of light perceived by the viewer of the 3D video image becomes more significant as the number of visual line directions produced by the parallax barrier 108 increases.

In view of this, the display device 2 of the self-luminous type is configured such that a luminance controlling section 23 controls a luminance of the three-dimensional pixel group so that the luminance becomes higher. Simultaneously, the luminance controlling section 23 controls an average luminance of the two-dimensional pixel group so that (i) the average luminance of the two-dimensional pixel group becomes lower than an average luminance of the three-dimensional pixel group and (ii) that the luminance of the two-dimensional pixel group becomes a level that makes a light intensity of the two-dimensional pixel group substantially equal to a light intensity of the display device 2 of a regular display state (a display state in which a sight-line-direction dividing section is not used). This configuration eliminates a sense of discomfort for both the viewer of the 3D video image and a viewer of a 2D video image.

[Operations for Case Where Two Viewers View 3D Video Image and 2D Video Image Respectively]

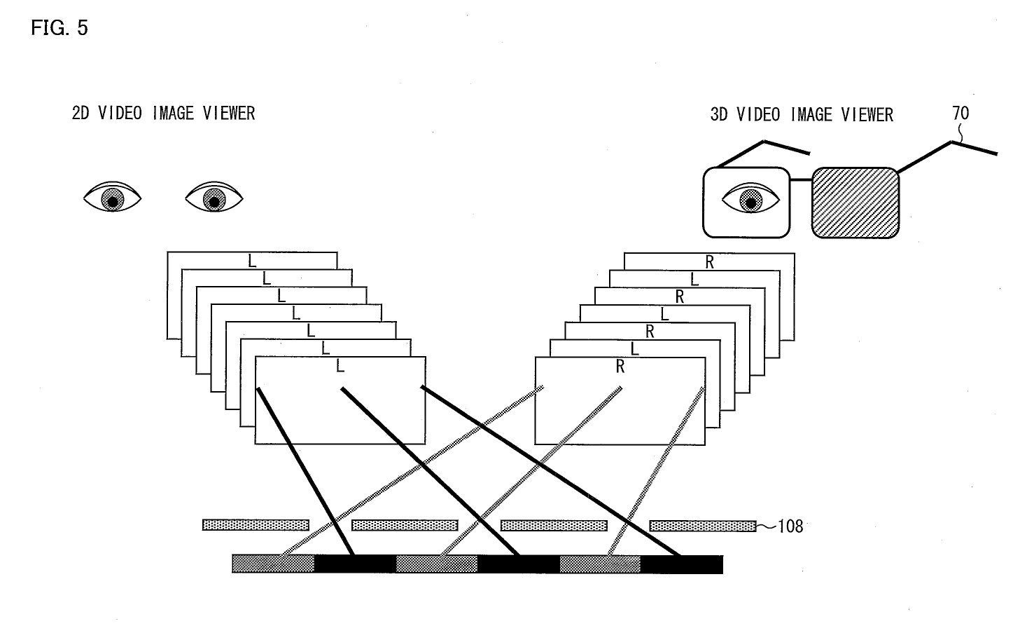

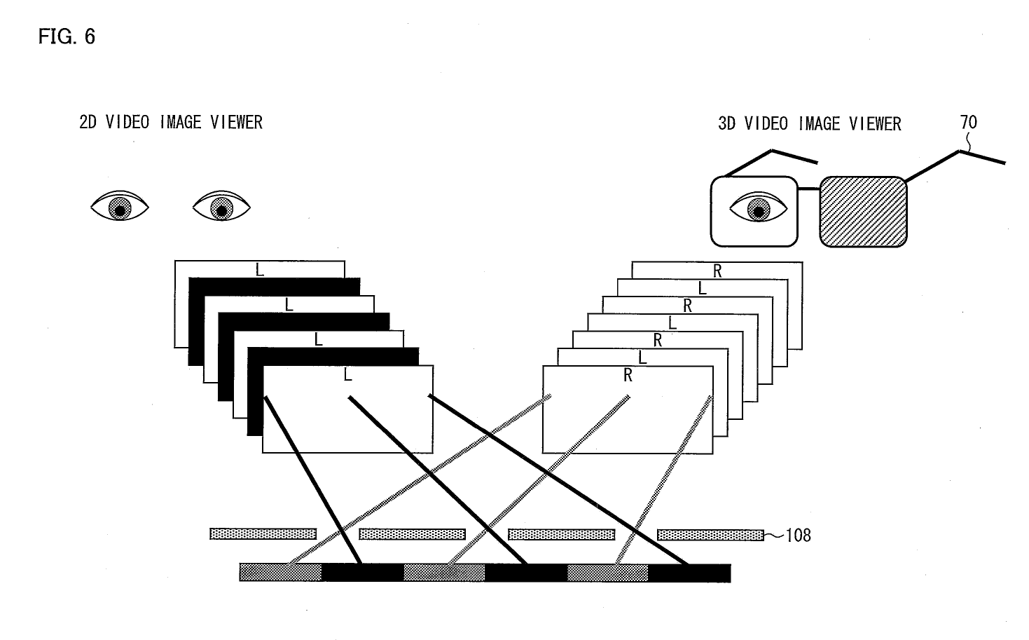

Next, the following description deals with operations in a case where two viewers view the 3D video image and the 2D video image respectively, with reference to FIGS. 5 and 6. Each of FIGS. 5 and 6 illustrates such an operation that the display device 1 allows (i) a viewer wearing the liquid-crystal shutter glasses 70 (hereinafter, also referred to as “3D video image viewer”) to view the 3D video image, and (ii) a viewer with naked eyes (hereinafter, also referred to as “2D video image viewer”) to view the 2D video image. FIG. 5 illustrates such an operation that no special process is performed on the 2D video image (the right-eye video image). Meanwhile, FIG. 6 illustrates such an operation that a scene (video image) where a color of pixels is black is inserted in the 2D video image (the right-eye image).

In each of the operations of FIGS. 5 and 6, (i) the right-eye video image and the left-eye video image, which can be used in three-dimensional display, are displayed on the display device 1, and (ii) the parallax barrier 108 causes (a) the right-eye video image and the left-eye video image to be displayed alternately in a direction toward the viewer of the 3D video image and (b) the right-eye video image (or the left-eye video image) to be displayed in a direction toward the viewer of the 2D video image. That is, the right-eye video image and the left-eye video image are displayed in a pixel group (the three-dimensional pixel group) associated with the direction toward the viewer of the 3D video image, and the right-eye video image is displayed in a pixel group (the two-dimensional pixel group) associated with the direction toward the viewer of the 2D video image.

Note that the operations for displaying the right-eye video image and the left-eye video image on the display device in such a manner are already explained in the above description with reference to FIG. 1, and therefore explanation of such operations is omitted here. Further, in each of FIGS. 5 and 6, the right-eye video image is abbreviated as “L”, and the left-eye video image is abbreviated as “R”.

As illustrated in FIG. 5, the viewer of the 2D video image views, with naked right and left eyes, the right-eye video image that is the 2D video image, and the viewer of the 3D video image views, via the liquid-crystal shutter glasses 70, (i) the right-eye video image with viewer's right eye and (ii) the left-eye video image with viewer's left eye. In other words, on the display device 1 capable of displaying video images that are viewed by using of parallax of left and right eyes of a viewer, a plurality of viewers can view video images in different display modes so that one(s) of the plurality of viewers can view the 2D video image and the other one(s) of the plurality of viewers can view the 3D video image.

Note, however, that the operation illustrated in FIG. 5 has the following intrinsic problems.

That is, in the operation illustrated in FIG. 5, the plurality of pixels in the display section are divided into the three-dimensional pixel group and the two-dimensional pixel group, and each of these pixel groups displays a different video image. For this reason, a light intensity of each of the pixel groups is decreased to a half of a light intensity of the display section of a regular display state (a display state in which the parallax barrier 108 is not used). Moreover, since a light transmittance of the liquid-crystal shutter glasses 70 is low, an intensity of light perceived by the viewer of the 3D video image is further decreased. Such a decrease in the intensity of light perceived by the viewer of the 3D video image becomes more significant when separate video images are respectively displayed in three or more sight line directions by use of the parallax barrier. Accordingly, in order to increase an intensity of light perceived by the viewer of the 3D video image, the display device 1 increases a luminance of the backlight.

However, in the display device 1, the three-dimensional pixel group and the two-dimensional pixel group share a single backlight and accordingly, an increase in luminance of the backlight results in an excess increase in an intensity of light perceived by the viewer of the 2D video image.

In view of this, it is preferable to decrease a luminance of the two-dimensional pixel group. The above description has dealt with a configuration, as a technique, for decreasing a luminance of the two-dimensional pixel group. In the technique, the light transmittance controlling section 22 decreases a light transmittance of the two-dimensional pixel group. Meanwhile, FIG. 6 illustrates another technique for decreasing a luminance of the two-dimensional pixel group. In the technique illustrated in FIG. 6, a scene (a video image) where a color of the pixels is black is inserted in sequential images of the right-eye video image. With this configuration, a luminance of the two-dimensional pixel group is adjusted to such a level that the viewer of the 2D video image can view the 2D video image comfortably. Note that though in FIG. 6, the scene (the video image) where a color of the pixels is black is inserted in the sequential images of the right-eye video image, the present embodiment is not limited to this. It is also possible to decrease a luminance of the two-dimensional pixel group by inserting, in the sequential images of the right-eye video image, a state (a video image) whose luminance is lower than that of the right-eye video image.

The technique illustrated in FIG. 6 is realized by the following operation.

That is, in FIG. 2, the video-image signal generating section 12 causes the two-dimensional video-image signal to contain a low-luminance video-image signal for displaying a low-luminance video image having a luminance lower than that of the right-eye video image or the left-eye video image displayed on the two-dimensional pixel group. Then, in accordance with the two-dimensional video-image signal created by the video-image signal generating section 12, the pixel-group display controlling section 13 causes the two-dimensional pixel group to display (i) the right-eye video image or the left-eye video image and (ii) the low-luminance video image. Here, it is possible (i) to alternately display the right-eye video image (or the left-eye video image) and the low-luminance video image in the display section 60, or (ii) to display the right-eye video image (or the left-eye video image) and the low-luminance video image at a discretionally specified proportion in the display section 60. This configuration can be modified as appropriate, as long as the intensity of light perceived by the viewer of the 2D video image can be decreased.

In the above description, the term “low-luminance video image” is used. Note, however, that the “low-luminance video image” is not necessarily a video image but can be realized in any form or any manner, as long as it is possible to realize a display state in which a luminance becomes lower than that of the right-eye video image or the left-eye video image.

Further, as other techniques for decreasing a luminance of the two-dimensional pixel group, there are (i) a technique in which the luminance is decreased by decreasing a light transmittance of the two-dimensional pixel group and (ii) a technique in which the luminance is decreased by providing a time period during which a light transmittance of the two-dimensional pixel group is set substantially 0. With these techniques, it is also possible to decrease a sense of discomfort for the viewer of the 2D video image. Furthermore, it is possible, as a matter of course, to configure the display device 1 (2) to employ an appropriate combination of the above techniques.

### [Effects Obtained by Display Devices 1 and 2]

The following discusses effects obtained by the display devices 1 and 2.

The display device 1 (2) displays parallax video images viewed by using parallax of left and right eyes of a viewer and allowing the viewer to view a stereoscopic video image via the liquid crystal shutter glasses 70 for switching whether or not to allow each of the right and left eyes to view the stereoscopic video image. The display device 1 (2) includes: the parallax barrier 108 producing a plurality of sight line directions of the parallax video images displayed in the display section 60 so that the parallax video images are displayed separately in the plurality of sight line directions; and the display controlling section 10 controlling, for each of the plurality of sight line directions, display of the parallax video images and allowing the stereoscopic video image to be viewed via the liquid crystal shutter glasses 70, the parallax video images being displayed separately in the plurality of sight line directions produced by the parallax barrier 108.

A display control method of the present invention for displaying parallax video images viewed by using parallax of left and right eyes of a viewer and allowing the viewer to view a stereoscopic video image via the liquid crystal shutter glasses 70 for switching whether or not to allow each of the right and left eyes to view the stereoscopic video image. The display control method includes the steps of: displaying the parallax video images in the display section 60 provided in a display device 1 (2) so that the parallax video images are displayed separately in a plurality of sight line directions produced by the parallax barrier 108 provided in the display device 1 (2); and controlling, for each of the plurality of sight line directions, display of the parallax video images and allowing the stereoscopic video image to be viewed via the liquid crystal shutter glasses 70, the parallax video images being displayed separately in the plurality of sight line directions produced by the parallax barrier 108.

In the above configuration, the parallax barrier 108 produces a plurality of sight line directions of parallax video images displayed in the display section 60 so that the parallax video images are displayed separately in the plurality of sight line directions. At this time, the display controlling section 10 controls, for each of the plurality of sight line directions, display of the parallax video images displayed separately in the plurality of sight line directions produced by the parallax barrier 108. Therefore, the display controlling section 10 makes it possible to realize a viewing mode in which a viewer can view a stereoscopic video image via the liquid crystal shutter glasses 70 in addition to a viewing mode in which a viewer can view parallax video images directly without the liquid crystal shutter glasses 70.

As described above, the display device 1 (2) (display control method) solves a conventional problem, that is, a problem that there has been no display device that is capable of displaying a stereoscopic video image viewed by using parallax of right and left eyes and that also includes a parallax barrier such as a parallax barrier. In addition, in a case where a plurality of viewers are present and, among the plurality of viewers, at least one viewer desires to view a parallax video image (2D video image) and other viewer(s) desires to view a stereoscopic video image (3D video image), the display device 1 (2) can allow each of the plurality of viewers to respectively view video images of different display modes. Therefore, the display device 1 (2) also can simultaneously satisfy requests of the plurality of viewers.

Note that in the display device 1 (2) (display control method) of the present invention, the parallax barrier 108 produces a plurality of sight line directions so that the parallax video images displayed in the display section 60 are displayed separately in the plurality of sight line directions. Therefore, even when three or more viewers are present, the display device 1 (2) of the present invention is capable of simultaneously realizing viewing modes that the three or more viewers respectively desire. In this point, the present invention also provides a display device that is more convenient.

The display device 1 (2) may be configured such that: the display section 60 includes a plurality of pixels; and the display controlling section 10 controls, for each one of pixel groups, display of the parallax video images in the each one pixel group, the each one pixel group being associated with one sight line direction from among the plurality of sight line directions.

According to the above configuration, for each pixel group associated with one sight line direction, display control of parallax video images is performed. The display control for each pixel group causes a video image associated with a single display mode (3D video image/2D video image) to be displayed in a single sight line direction. This makes it possible to reliably exclude a viewing mode that a viewer does not desire. For example, when a viewer desires to view a 2D video image, only a 2D video image is displayed in a pixel group associated with one sight line direction and in this sight line direction, no 3D video image is displayed. This prevents the viewer positioned in the one sight line direction from getting 3D sickness and makes the viewer to feel comfortable in viewing a display.

The display device 1 (2) may be configured such that the display controlling section 10 causes a pixel group associated with a first sight line direction to alternately display a left-eye video image and a right-eye video image that are the parallax video images, which pixel group is one of the pixel groups, and also causes another pixel group associated with a second sight line direction to display the right-eye video image or the left-eye video image, which second sight light direction is different from the first sight line direction.

In general, by alternately displaying a right-eye video image and a left-eye video image which are parallax video images viewed by using parallax of left and right eyes of a viewer, 3D video image display is realized. Further, when only either one of the right-eye video image and the left-eye video image is displayed, conventional 2D display is realized.

Accordingly, the display controlling section 10 can realize (i) a stereoscopic video image display in a pixel group associated with a first sight line direction, by causing a right-eye video image and a left-eye video image that are of parallax images to be displayed alternately in the pixel group associated with the first sight line direction and (ii) 2D video image display in a pixel group associated with a second sight line direction that is different from the first sight line direction, by causing either the right-eye video image or left-eye video image to be displayed in the pixel group associated with the second sight line direction.

Therefore, with the above configuration, it is possible to allow each of a plurality of viewers to view a video image of a different display mode, reliably, in a case where a viewer who wishes to view a parallax video image (2D video image) and a viewer who wishes to view a stereoscopic video image (3D video image) are mixedly present.

The display device 1 (2) of the present invention may be configured such that: the display controlling section 10 includes: the pixel-group determining section 11 determining, from among the pixel groups, each of (i) a three-dimensional pixel group caused to alternately display the right-eye video image and the left-eye video image and (ii) a two-dimensional pixel group caused to display the right-eye video image or the left-eye video image; and the pixel-group display controlling section 13 causing the three-dimensional pixel group to display the right-eye video image and the left-eye video image whereas causing the two-dimensional pixel group to display the right-eye video image or the left-eye video image.

With the above configuration, the pixel-group determining section 11 determines a three-dimensional pixel group in which a stereoscopic video image is displayed and a two-dimensional pixel group in which a 2D video image is displayed. Here, the pixel-group determining section 11 determines the three-dimensional pixel group and the two-dimensional pixel group, for example, according to a setting in which a 3D video image is to be displayed in the first sight line direction and a 2D video image is to be displayed in the second sight line direction that is different from the first sight line direction.

Then, the pixel-group display controlling section 13 causes the right-eye video image and the left-eye video image to be displayed in the three-dimensional pixel group, and the right-eye video image or the left-eye video image to be displayed in the two-dimensional pixel group. This allows each of a plurality of viewers to view either one of a 3D video image and a 2D video image.

As described above, the display controlling section 10 allows each of a plurality of viewers to view a video image of a different display mode, in a case where there are mixedly present (i) a viewer who wishes to view a 3D video image formed by the right-eye video image and the left-eye video image and (ii) a viewer who wishes to view a 2D video image formed by the right-eye video image and the left-eye video image. This makes it possible to simultaneously satisfy requests of the plurality of viewers.

The display device 1 (2) may be configured to further includes the luminance controlling section making a luminance of the three-dimensional pixel group higher than a luminance of the three-dimensional pixel group of a case where the right-eye video image and the left-eye video image are displayed without use of the parallax barrier 108.

In the display device 1 (2), a plurality of pixels in the display section 60 are divided into the three-dimensional pixel group and the two-dimensional pixel group. Further, in the three-dimensional pixel group and the two-dimensional pixel group, separate video images subjected to display control are displayed, respectively. Accordingly, a light intensity in each of these groups becomes lower as compared to that in a regular display state (a display state where the parallax barrier 108 is not used). Furthermore, a viewer of a 3D video image views the 3D image via the liquid crystal shutter glasses 70. Accordingly, depending on a structure of the liquid crystal shutter glasses 70, a light transmittance becomes lower and consequently an intensity of light perceived by the viewer of the 3D video image further decreases. This decrease in light intensity becomes more significant as the number of sight line directions produced by the liquid crystal shutter glasses 70 increases.

However, in the display device 1 (2) of the present invention, the luminance controlling section makes a luminance of the three-dimensional pixel group higher than a luminance of the three-dimensional pixel group of a case where the right-eye video image and the left-eye video image are displayed without use of the parallax barrier 108. This makes it possible to increase an intensity of light perceived by the viewer of the 3D video image and to eliminate a sense of discomfort for the viewer.

The display device 1 (2) may be configured such that the luminance controlling section 21 increases a luminance of a backlight of the display device 1 (2) itself.

In the above configuration, the luminance controlling section 21 increases a luminance of a backlight of the display device 1 (2) itself. This can increase a luminance of the three-dimensional pixel group. Accordingly, it becomes possible to increase an intensity of light perceived by a view of a 3D video image and thereby to eliminate a sense of discomfort for the viewer.

The display device 1 (2) may be configured to further include the light transmittance controlling section 22 decreasing a light transmittance of the two-dimensional pixel group so that a light intensity of the two-dimensional pixel group becomes substantially equal to a light intensity of a time when the right-eye video image or the left-eye video image is displayed in the two-dimensional pixel group without use of the parallax barrier 108.

As described above, because the luminance controlling section increases a luminance of the three-dimensional pixel group, there may arise a case where a light intensity of the two-dimensional pixel group increases. For example, when the luminance controlling section 21 increases a luminance of the backlight, a light intensity for a viewer of a 2D video image increases too much. This is because the two-dimensional pixel group shares the backlight with the three-dimensional pixel group.

However, in the display device 1 (2), the light transmittance controlling section 22 decreases a light transmittance of the two-dimensional pixel group so that a light intensity of the two-dimensional pixel group becomes substantially equal to a light intensity of a time when the right-eye video image or the left-eye video image is displayed in the two-dimensional pixel group without use of the parallax barrier 108. This makes it possible to decrease a light intensity of the two-dimensional pixel group and thereby to decrease an intensity of light perceived by the viewer of the 2D video image. This can eliminate a sense of discomfort for the viewer.

The display device 1 (2) may be configured such that the pixel-group display controlling section 13 inserts, into the right-eye video image or the left-eye video image to be displayed, a low luminance video image whose luminance is lower than that of the right-eye video image or the left-eye video image to be displayed in the two-dimensional pixel group, and then causes the two-dimensional pixel group to display the right-eye video image or the left-eye video image into which the low luminance video image is inserted.

The above configuration makes it possible to decrease an average luminance of the two-dimensional pixel group, because a video image displayed in the two-dimensional pixel group is a video image obtained by inserting a low luminance video image into the right-eye video image or the left-eye video image. Therefore, an intensity of light perceived by a viewer of a 2D video image can be decreased. This can eliminate a sense of discomfort for the viewer.

Note that the “low luminance video image” in the above description is not necessarily a video image itself. As long as it is possible to produce a state where a luminance is lower than that of the right-eye video image or the left-eye video image, the configuration may be realized in any form or any manner.

The display device 1 (2) may be configured such that the luminance controlling section increases a luminance of the three-dimensional pixel group.

In the above configuration, the luminance controlling section 21 increases a luminance of the three-dimensional pixel group itself. This can increase an intensity of light perceived by a viewer of a 3D video image and thereby can eliminate a sense of discomfort for the viewer.

The display device 1 (2) may be configured to further include the luminance controlling section 23 decreasing a luminance of the two-dimensional pixel group so that a light intensity of the two-dimensional pixel group becomes substantially equal to a light intensity of the two-dimensional pixel group of the time when the right-eye video image or the left-eye video image is displayed in the two-dimensional pixel group without use of the parallax barrier 108.

As described above, when a light intensity of the two-dimensional pixel group increases due to an increase caused by the luminance controlling section in a luminance of the three-dimensional pixel group, there may arise a case where the light intensity increases too much for a viewer of a 2D video image.

In view of this, the luminance controlling section 23 decreases a luminance of the two-dimensional pixel group so that a light intensity becomes substantially equal to a light intensity of the time when the right-eye video image or the left-eye video image is displayed without use of the parallax barrier 108. As a result, the luminance of the two-dimensional pixel group can be. This makes it possible to decrease an intensity of light perceived by a viewer of a 2D video image and thereby, to eliminate a sense of discomfort for the viewer.

Further, the display device 1 (2) may be configured to further include the synchronization controlling section 30, in a case where the liquid crystal shutter glasses 70 are made of liquid-crystal shutter glasses including a right-eye liquid-crystal shutter and a left-eye liquid crystal shutter, the synchronization controlling section 30 (I) synchronizing (a) a display timing at which the pixel-group display controlling section 13 causes the three-dimensional pixel group to display the right-eye video image and (b) a shutter open/close timing for opening the right-eye liquid-crystal shutter and closing the left-eye liquid-crystal shutter and (II) also synchronizing (a) a display timing at which the pixel-group display controlling section 13 causes the three-dimensional pixel group to display the left-eye video image and (b) a shutter open/close timing for closing the right-eye liquid-crystal shutter and opening the left-eye liquid-crystal shutter.

In the above configuration, the synchronization controlling section 30 can suitably synchronize (i) a display timing at which the pixel-group display controlling section 13 causes the three-dimensional pixel group to display the right-eye video image or the left-eye video image with (ii) a timing for opening/closing each shutter of liquid-crystal shutter glasses.

Therefore, a viewer can reliably view a 3D video image that is displayed in the three-dimensional pixel group via the liquid-crystal shutter glasses 70.

Further, the display device 1 (2) may be configured such that the pixel-group determining section 11 determines the three-dimensional pixel group and the two-dimensional pixel group, in response to an input operation made by the viewer via the operation section 80.

In a case where there are a plurality of viewers and among these viewers, there are mixedly present a viewer who wishes to view a parallax video image (2D video image) and a viewer who wishes to view a stereoscopic video image (3D video image), there may be a case where it is desired to change and/or check sight line directions in which the parallax video image and the stereoscopic video image are respectively displayed.

In such a case, the pixel-group determining section 11 determines the three-dimensional pixel group and the two-dimensional pixel group, in response to an input operation made by the viewer via the operation section 80. This makes it possible to realize an embodiment in which (i) a sight line direction for a viewer who desires to view a stereoscopic video image (3D video image) is changed to a right side of the display device 1 (2) and (ii) a sight line direction for a viewer who desires to view a parallax video image (2D video image) is changed to a left side of the display device 1 (2). This makes it possible to provide a more convenient display device 1 (2).

The display device 1 (2) may be configured such that the parallax barrier 108 is provided in a detachable manner with respect to the display section 60.

Because the parallax barrier 108 is provided with respect to the display section 60 in a detachable manner, a viewer can detach the parallax barrier 108 when the viewer desires to view only a 2D video image or a 3D video image. This makes it possible to immediately and reliably realize a video image display mode that the viewer desires.

Note that the display control method of the present invention can be realized by a computer. In this case, the present invention encompasses a control program that causes a computer to carry out processing so that the display control method can be realized by the computer, and a computer-readable storage medium storing such a program.

Finally, the blocks of each of the display devices 1 and 2, in particular, the pixel-group determining section 11, the video-image signal generating section 12 and the pixel-group display controlling section 13 may be realized by way of hardware or software as executed by a CPU as follows.

The display devices 1 and 2 each include a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to each of the display devices 1 and 2 a computer-readable storage medium containing control program code (executable program, intermediate code program, or source program) for each of the display devices 1 and 2, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a Floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The display devices 1 and 2 each may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth®, 802.11 wireless, HDR, mobile telephone network, satellite line, or terrestrial digital network. The present invention encompasses a computer data signal embedded in a carrier wave in which the program code is embodied electronically.

[Others]

A display device of the present invention being a 3D video image display device utilizing parallax of right and left eyes of a viewer who views a display screen via a vision control mechanism provided with means for switching, in connection with the display screen, whether or not to allow each of right and left eyes to view the display screen, the display device may be configured to include sight-line dividing means (parallax barrier) and means that individually controls respective images to be displayed separately in sight lines produced by the sight-line dividing means.

Further, the display device of the present invention may be configured to include means that (i) increases a luminance of 3D video image display in a case where the 3D video image display is performed with use of the sight-line dividing means and (ii) thereby makes the luminance higher than a luminance of a case where 3D video image display is performed without use of the sight-line dividing means.

Further, the display device of the present invention may be a 3D video image display device provided with liquid crystals, and may be configured such that the means that increases the luminance performs control by which a luminance of a backlight for image display is increased.

Further, the display device of the present invention may be a 3D video image display device provided with a self-luminous element for image display, and may be configured such that the means that increases the luminance performs control by which a luminance of pixels themselves for the 3D image display is increased.

Further, the display device of the present invention may be configured to perform control by which a transmittance of pixel dots for 2D display is decreased so that a light intensity of a case where 2D video image display is performed with use of the sight-line dividing means becomes substantially equal to a light intensity of a case where 2D video image display is performed without use of the sight-line dividing means.

Further, the display device of the present invention may be configured to perform control by which a luminance of pixels for 2D display is increased so that a light intensity of a case where 2D video image display is performed with use of the sight-line dividing means becomes substantially equal to a light intensity of a case where 2D video image display is performed without use of the sight-line dividing means.

The present invention is not limited to the description of the embodiments above, but may be variously altered by a skilled person within the scope of the claims. The technical scope of the present invention encompasses an embodiment based on a proper combination of technical means altered/modified as appropriate within the scope of the claims.

Further, the display device of the present invention can be used in various applications. For example, the display device of the present invention is applicable not only to devices near at hand, such as televisions at home or the like, car navigations each performing display of different images respectively for a driver's seat and a passenger seat in an automobile, mobile phones, PDAs (Personal Digital Assistants: portable information communication devices for individuals), PCs, and television receivers, but also to measuring instruments, medical instruments, industrial equipment, etc.

[Others 2]

The following supplementally discusses a technical problem of Patent Literatures 1 and 2.

In techniques disclosed in Patent Literatures 1 and 2, there may be some viewers who get 3D sickness in viewing a 3D video image that is viewed by using parallax of right and left eyes. Further, there are not a few people who have visual disability in one eye, who do not have glasses for 3D viewing, who cannot purchase expensive 3D glasses, who feel it troublesome to wear glasses for 3D viewing, and the like. Such viewers inevitably wish to view not a 3D video image but a 2D video image. Then, when a plurality of viewers are present, there may arise a case where a viewer who wishes to view a 2D video image and another viewer who wishes to view a 3D video image are mixedly present.

In such a case, conventionally, there has not been a display device that is a 3D video image display device utilizing parallax of right and left eyes and that also includes a parallax barrier. Accordingly even when techniques of Patent Literatures 1 and 2 are employed, only display of either a 2D video image or a 3D video image has been possible. As a result, such a conventional display device has not been able to allow a plurality of viewers at different positions to simultaneously view both a 2D video image and a 3D video image via a parallax barrier. Therefore, in a case where a viewer who wishes to view a 2D video image and another viewer who wishes to view a 3D video image are mixedly present, it has not been possible to simultaneously satisfy requests of all viewers.

The present invention is attained in view of the above conventional problem. An object of the present invention is to provide a display device, a display control method, a display control program and a computer-readable storage medium each of which allows a plurality of viewers to respectively view video images of different display modes by use of video image dividing means in a display device that allows each viewer to view a stereoscopic video image via a visual-recognition switching mechanism for switching whether or not to allow each of right and left eyes to view the stereoscopic video image.

The display device of the present invention may be configured such that: the display section includes a plurality of pixels; and the display control means controls, for each one of pixel groups, display of the parallax video images in the each one pixel group, the each one pixel group being associated with one sight line direction from among the plurality of sight line directions.

According to the above configuration, for each pixel group associated with one sight line direction, display control of parallax video images is performed. The display control for each pixel group causes a video image associated with a single display mode (3D video image/2D video image) to be displayed in a single sight line direction. This makes it possible to reliably exclude a viewing mode that a viewer does not desire. For example, when a viewer desires to view a 2D video image, only a 2D video image is displayed in a pixel group associated with one sight line direction and in this sight line direction, no 3D video image is displayed. This prevents the viewer positioned in the one sight line direction from getting 3D sickness and makes the viewer to feel comfortable in viewing a display.

The display device of the present invention may be configured such that the display control means causes a pixel group associated with a first sight line direction to alternately display a left-eye video image and a right-eye video image that are the parallax video images, which pixel group is one of the pixel groups, and also causes another pixel group associated with a second sight line direction to display the right-eye video image or the left-eye video image, which second sight light direction is different from the first sight line direction.

In general, by alternately displaying a right-eye video image and a left-eye video image which are parallax video images viewed by using parallax of left and right eyes of a viewer, 3D video image display is realized. Further, when only either one of the right-eye video image and the left-eye video image is displayed, conventional 2D display is realized.

Accordingly, the display control means can realize (i) a stereoscopic video image display in a pixel group associated with a first sight line direction, by causing a right-eye video image and a left-eye video image that are of parallax images to be displayed alternately in the pixel group associated with the first sight line direction and (ii) 2D video image display in a pixel group associated with a second sight line direction that is different from the first sight line direction, by causing either the right-eye video image or left-eye video image to be displayed in the pixel group associated with the second sight line direction.

Therefore, with the above configuration, it is possible to allow each of a plurality of viewers to view a video image of a different display mode, reliably, in a case where a viewer who wishes to view a parallax video image (2D video image) and a viewer who wishes to view a stereoscopic video image (3D video image) are mixedly present.

The display device of the present invention may be configured such that: the display control means includes: pixel-group determination means determining, from among the pixel groups, each of (i) a three-dimensional pixel group caused to alternately display the right-eye video image and the left-eye video image and (ii) a two-dimensional pixel group caused to display the right-eye video image or the left-eye video image; and pixel-group display control means causing the three-dimensional pixel group to display the right-eye video image and the left-eye video image whereas causing the two-dimensional pixel group to display the right-eye video image or the left-eye video image.

With the above configuration, the pixel-group determination means determines a three-dimensional pixel group in which a stereoscopic video image is displayed and a two-dimensional pixel group in which a 2D video image is displayed. Here, the pixel-group determination means determines the three-dimensional pixel group and the two-dimensional pixel group, for example, according to a setting in which a 3D video image is to be displayed in the first sight line direction and a 2D video image is to be displayed in the second sight line direction that is different from the first sight line direction.

Then, the pixel-group display control means causes the right-eye video image and the left-eye video image to be displayed in the three-dimensional pixel group, and the right-eye video image or the left-eye video image to be displayed in the two-dimensional pixel group. This allows a plurality of viewers to respectively view a 3D video image and a 2D video image.

As described above, the display control means allows each of a plurality of viewers to view a video image of a different display mode, in a case where there are mixedly present (i) a viewer who wishes to view a 3D video image formed by the right-eye video image and the left-eye video image and (ii) a viewer who wishes to view a 2D video image formed by the right-eye video image and the left-eye video image. This makes it possible to simultaneously satisfy requests of the plurality of viewers.

The display device of the present invention may be configured to further includes first luminance control means making a luminance of the three-dimensional pixel group higher than a luminance of the three-dimensional pixel group of a case where the right-eye video image and the left-eye video image are displayed without use of the sight-line-direction dividing section.

In the display device of the present invention, a plurality of pixels in the display section are divided into the three-dimensional pixel group and the two-dimensional pixel group. Further, in the three-dimensional pixel group and the two-dimensional pixel group, separate video images subjected to display control are displayed, respectively. Accordingly, a light intensity in each of these groups becomes lower as compared to that in a regular display state (a display state where the sight-line-direction dividing section is not used). Furthermore, a viewer of a 3D video image views the 3D image via the visual-recognition switching mechanism. Accordingly, depending on a structure of the visual-recognition switching mechanism, a light transmittance becomes lower and consequently an intensity of light perceived by the viewer of the 3D video image further decreases. This decrease in light intensity becomes more significant as the number of sight line directions produced by the visual recognition switching mechanism increases.

However, in the display device of the present invention, the first luminance control means makes a luminance of the three-dimensional pixel group higher than a luminance of the three-dimensional pixel group of a case where the right-eye video image and the left-eye video image are displayed without use of the sight-line-direction dividing section. This makes it possible to increase an intensity of light perceived by the viewer of the 3D video image and to eliminate a sense of discomfort for the viewer.

The display device of the present invention may be configured such that the first luminance control means increases a luminance of a backlight of the display device itself.

In the above configuration, the first luminance control means increases a luminance of a backlight of the display device itself. This can increase a luminance of the three-dimensional pixel group. Accordingly, it becomes possible to increase an intensity of light perceived by a view of a 3D video image and thereby to eliminate a sense of discomfort for the viewer.

The display device of the present invention may be configured to further include light transmittance control means decreasing a light transmittance of the two-dimensional pixel group so that a light intensity of the two-dimensional pixel group becomes substantially equal to a light intensity of a time when the right-eye video image or the left-eye video image is displayed in the two-dimensional pixel group without use of the sight-line-direction dividing section.

As described above, because the first luminance control means increases a luminance of the three-dimensional pixel group, there may arise a case where a light intensity of the two-dimensional pixel group increases. For example, when the first luminance control means increases a luminance of the backlight, a light intensity for a viewer of a 2D video image increases too much. This is because the two-dimensional pixel group shares the backlight with the three-dimensional pixel group.

However, in the display device of the present invention, the light transmittance control means decreases a light transmittance of the two-dimensional pixel group so that a light intensity of the two-dimensional pixel group becomes substantially equal to a light intensity of a time when the right-eye video image or the left-eye video image is displayed in the two-dimensional pixel group without use of the sight-line-direction dividing section. This makes it possible to decrease a light intensity of the two-dimensional pixel group and thereby to decrease an intensity of light perceived by the viewer of the 2D video image. This can eliminate a sense of discomfort for the viewer.

The display device of the present invention may be configured such that the pixel-group display control means inserts, into the right-eye video image or the left-eye video image to be displayed, a low luminance video image whose luminance is lower than that of the right-eye video image or the left-eye video image to be displayed in the two-dimensional pixel group, and then causes the two-dimensional pixel group to display the right-eye video image or the left-eye video image into which the low luminance video image is inserted.

The above configuration makes it possible to decrease an average luminance of the two-dimensional pixel group, because a video image displayed in the two-dimensional pixel group is a video image obtained by inserting a low luminance video image into the right-eye video image or the left-eye video image. Therefore, an intensity of light perceived by a viewer of a 2D video image can be decreased. This can eliminate a sense of discomfort for the viewer.

Note that the “low luminance video image” in the above description is not necessarily a video image itself. As long as it is possible to produce a state where a luminance is lower than that of the right-eye video image or the left-eye video image, the configuration may be realized in any form or any manner.

The display device of the present invention may be configured such that the first luminance control means increases a luminance of the three-dimensional pixel group.

In the above configuration, the first luminance control means increases a luminance of the three-dimensional pixel group itself. This can increase an intensity of light perceived by a viewer of a 3D video image and thereby can eliminate a sense of discomfort for the viewer.

The display device of the present invention may be configured to further include second luminance control means decreasing a luminance of the two-dimensional pixel group so that a light intensity of the two-dimensional pixel group becomes substantially equal to a light intensity of the two-dimensional pixel group of the time when the right-eye video image or the left-eye video image is displayed in the two-dimensional pixel group without use of the sight-line-direction dividing section.

As described above, when a light intensity of the two-dimensional pixel group increases due to an increase caused by the first luminance control means in a luminance of the three-dimensional pixel group, there may arise a case where the light intensity increases too much for a viewer of a 2D video image.

In view of this, the second luminance control means decreases a luminance of the two-dimensional pixel group so that a light intensity becomes substantially equal to a light intensity of the time when the right-eye video image or the left-eye video image is displayed without use of the sight-line-direction dividing section. As a result, the luminance of the two-dimensional pixel group can be. This makes it possible to decrease an intensity of light perceived by a viewer of a 2D video image and thereby, to eliminate a sense of discomfort for the viewer.

Further, the display device of the present invention may be configured to further include synchronization control means, in a case where the visual-recognition switching mechanism is made of liquid-crystal shutter glasses including a right-eye liquid-crystal shutter and a left-eye liquid crystal shutter, the synchronization control means (I) synchronizing (a) a display timing at which the pixel-group display control means causes the three-dimensional pixel group to display the right-eye video image and (b) a shutter open/close timing for opening the right-eye liquid-crystal shutter and closing the left-eye liquid-crystal shutter and (II) also synchronizing (a) a display timing at which the pixel-group display control means causes the three-dimensional pixel group to display the left-eye video image and (b) a shutter open/close timing for closing the right-eye liquid-crystal shutter and opening the left-eye liquid-crystal shutter.

In the above configuration, the synchronization control means can suitably synchronize (i) a display timing at which the pixel-group display control means causes the three-dimensional pixel group to display the right-eye video image or the left-eye video image with (ii) a timing for opening/closing each shutter of liquid-crystal shutter glasses.

Therefore, a viewer can reliably view a 3D video image that is displayed in the three-dimensional pixel group via the liquid-crystal shutter glasses.

Further, the display device of the present invention may be configured such that the pixel-group determination means determines the three-dimensional pixel group and the two-dimensional pixel group, in response to an input operation made by the viewer via an operation section.

In a case where there are a plurality of viewers and among these viewers, there are mixedly present a viewer who wishes to view a parallax video image (2D video image) and a viewer who wishes to view a stereoscopic video image (3D video image), there may be a case where it is desired to change and/or check sight line directions in which the parallax video image and the stereoscopic video image are respectively displayed.

In such a case, the pixel-group determination means determines the three-dimensional pixel group and the two-dimensional pixel group, in response to an input operation made by the viewer via an operation section. This makes it possible to realize an embodiment in which (i) a sight line direction for a viewer who desires to view a stereoscopic video image (3D video image) is changed to a right side of the display device and (ii) a sight line direction for a viewer who desires to view a parallax video image (2D video image) is changed to a left side of the display device. This makes it possible to provide a more convenient display device.

The display device of the present invention may be configured such that the sight-line-direction dividing section is provided in a detachable manner with respect to the display section.

Because the sight-line-direction dividing section is provided with respect to the display section in a detachable manner, a viewer can detach the sight-line-direction dividing section when the viewer desires to view only a 2D video image or a 3D video image. This makes it possible to immediately and reliably realize a video image display mode that the viewer desires.

Note that the display control method may be realized by a computer. In such a case, the present invention encompasses a display control program causing a computer to perform an operation of the process and thereby realizing the display control method by the computer, and a computer-readable storage medium storing the display control program recorded therein.

### INDUSTRIAL APPLICABILITY

The present invention relates to a display device allowing a viewer to view a stereoscopic video image via a visual-recognition switching mechanism for switching whether to allow each of the right and left eyes to view the stereoscopic video image, which display device can allow a plurality of viewers to respectively view video images of different display modes by use of video image dividing means such as a parallax barrier. The present invention can be suitably applied to a liquid crystal display device, a self-luminous display device such as a plasma display device.

### REFERENCE SIGNS LIST

1, 2 display device
5 control section
10 display controlling section (display control means)
11 pixel-group determining section (pixel-group determination means)
12 video-image signal generating section (video-image signal generation means)
13 pixel-group display controlling section (pixel-group display control means)
20 light intensity controlling section
21 luminance controlling section (first luminance control means)
22 light transmittance controlling section (light transmittance control means)
23 luminance controlling section (second luminance control means)
30 synchronization controlling section (synchronization control means)
40 content receiving section
50 command signal outputting section
60 display section
70, 70A, 70B liquid-crystal shutter glasses (visual-recognition switching mechanism)
80 operation section
90 recording/reproducing device
95 relay
100 liquid crystal panel
101 backlight
102, 103 polarizing plate
104 TFT substrate
105 liquid crystal layer
106 color filter substrate
107 glass substrate
108 parallax barrier (sight-line-direction dividing section)

1. A display device capable of displaying a two-dimensional video image and a three-dimensional video image that is viewed by using parallax of left and right eyes of a viewer, the display device comprising:
pixel determination means determining, automatically or in response to an input operation of a viewer, a three-dimensional pixel group for a three-dimensional video image and a two-dimensional pixel group for a two-dimensional video image from among pixels in a display section of the display device;
pixel-group display control means individually controlling display of each of the three-dimensional pixel group and the two-dimensional pixel group; and
a parallax barrier of a parallax type or lenticular type.

2. The display device as set forth in claim 1, further comprising light intensity control means that increases a backlight luminance and also decreases a light transmittance of the two-dimensional pixel group, when the two-dimensional video image and the three-dimensional video image are displayed.

3. A display device displaying parallax video images viewed by using parallax of left and right eyes of a viewer and allowing the viewer to view a stereoscopic video image via a visual-recognition switching mechanism for switching whether or not to allow each of the right and left eyes to view the stereoscopic video image, the display device comprising:
a sight-line-direction dividing section producing a plurality of sight line directions of the parallax video images displayed in a display section so that the parallax video images are displayed separately in the plurality of sight line directions; and
display control means controlling, for each of the plurality of sight line directions, display of the parallax video images and allowing the stereoscopic video image to be viewed via the visual-recognition switching mechanism, the parallax video images being displayed separately in the plurality of sight line directions produced by the sight-line-direction dividing section.

4. The display device as set forth in claim 3, wherein:
the display section includes a plurality of pixels; and
the display control means controls, for each one of pixel groups, display of the parallax video images in the each one pixel group, the each one pixel group being associated with one sight line direction from among the plurality of sight line directions.

5. The display device as set forth in claim 4, wherein the display control means causes a pixel group associated with a first sight line direction to alternately display a left-eye video image and a right-eye video image that are the parallax video images, which pixel group is one of the pixel groups, and also causes another pixel group associated with a second sight line direction to display the right-eye video image or the left-eye video image, which second sight light direction is different from the first sight line direction.

6. The display device as set forth in claim 5, wherein:
the display control means includes:
pixel-group determination means determining, from among the pixel groups, each of (i) a three-dimensional pixel group caused to alternately display the right-eye video image and the left-eye video image and (ii) a two-dimensional pixel group caused to display the right-eye video image or the left-eye video image; and
pixel-group display control means causing the three-dimensional pixel group to display the right-eye video image and the left-eye video image whereas causing the two-dimensional pixel group to display the right-eye video image or the left-eye video image.

7. The display device as set forth in claim 6, further comprising first luminance control means making a luminance of the three-dimensional pixel group higher than a luminance of the three-dimensional pixel group of a case where the right-eye video image and the left-eye video image are displayed without use of the sight-line-direction dividing section.

8. The display device as set forth in claim 7, wherein the first luminance control means increases a luminance of a backlight of the display device itself.

9. The display device as set forth in claim 7, further comprising light transmittance control means decreasing a light transmittance of the two-dimensional pixel group so that a light intensity of the two-dimensional pixel group becomes substantially equal to a light intensity of a time when the right-eye video image or the left-eye video image is displayed in the two-dimensional pixel group without use of the sight-line-direction dividing section.

10. The display device as set forth in claim 7, wherein the pixel-group display control means inserts, into the right-eye video image or the left-eye video image to be displayed, a low luminance video image whose luminance is lower than that of the right-eye video image or the left-eye video image to be displayed in the two-dimensional pixel group, and then causes the two-dimensional pixel group to display the right-eye video image or the left-eye video image into which the low luminance video image is inserted.

11. The display device as set forth in claim 7, wherein the first luminance control means increases a luminance of the three-dimensional pixel group.

12. The display device as set forth in claim 7, further comprising second luminance control means decreasing a luminance of the two-dimensional pixel group so that a light intensity of the two-dimensional pixel group becomes substantially equal to a light intensity of the two-dimensional pixel group of the time when the right-eye video image or the left-eye video image is displayed in the two-dimensional pixel group without use of the sight-line-direction dividing section.

13. The display device as set forth in claim 6, further comprising synchronization control means,
in a case where the visual-recognition switching mechanism is made of liquid-crystal shutter glasses including a right-eye liquid-crystal shutter and a left-eye liquid crystal shutter, the synchronization control means (I) synchronizing (a) a display timing at which the pixel-group display control means causes the three-dimensional pixel group to display the right-eye video image and (b) a shutter open/close timing for opening the right-eye liquid-crystal shutter and closing the left-eye liquid-crystal shutter and (II) also synchronizing (a) a display timing at which the pixel-group display control means causes the three-dimensional pixel group to display the left-eye video image and (b) a shutter open/close timing for closing the right-eye liquid-crystal shutter and opening the left-eye liquid-crystal shutter.

14. The display device as set forth in claim 6, wherein the pixel-group determination means determines the three-dimensional pixel group and the two-dimensional pixel group, in response to an input operation made by the viewer via an operation section.

15. The display device as set forth in claim 3, wherein the sight-line-direction dividing section is provided in a detachable manner with respect to the display section.

16. A display control method for displaying parallax video images viewed by using parallax of left and right eyes of a viewer and allowing the viewer to view a stereoscopic video image via a visual-recognition switching mechanism for switching whether or not to allow each of the right and left eyes to view the stereoscopic video image, the display control method comprising the steps of:
displaying the parallax video images in a display section provided in a display device so that the parallax video images are displayed separately in a plurality of sight line directions produced by a sight-line-direction dividing section provided in the display device; and
controlling, for each of the plurality of sight line directions, display of the parallax video images and allowing the stereoscopic video image to be viewed via the visual-recognition switching mechanism, the parallax video images being displayed separately in the plurality of sight line directions produced by the sight-line-direction dividing section.

17. (canceled)

18. A non-transitory computer-readable storage medium storing a display control program for causing a computer to execute a process for, in a display control method for displaying parallax video images viewed by using parallax of left and right eyes of a viewer and allowing the viewer to view a stereoscopic video image via a visual-recognition switching mechanism for switching whether or not to allow each of the right and left eyes to view the stereoscopic video image, the display control method comprising the steps of: displaying the parallax video images in a display section provided in a display device so that the parallax video images are displayed separately in a plurality of sight line directions produced by a sight-line-direction dividing section provided in the display device; and controlling, for each of the plurality of sight line directions, display of the parallax video images and allowing the stereoscopic video image to be viewed via the visual-recognition switching mechanism, the parallax video images being displayed separately in the plurality of sight line directions produced by the sight-line-direction dividing section, performing the step of controlling display of parallax video images, for each sight line direction.
